(19) United States
(12) Patent Application Publication
(10) Pub. No.: US 2014/0052925 A1
(43) Pub. Date: Feb. 20, 2014

(54) SYSTEM AND METHOD FOR WRITE-LIFE EXTENSION OF STORAGE RESOURCES

(71) Applicants: Gary B. Kotzur, Austin, TX (US); Jason P. Gross, Portland, OR (US)

(72) Inventors: Gary B. Kotzur, Austin, TX (US); Jason P. Gross, Portland, OR (US)

(73) Assignee: DELL PRODUCTS L.P., Round Rock, TX (US)

(21) Appl. No.: 13/588,693

(22) Filed: Aug. 17, 2012

(51) Int. Cl. G06F 12/12

(52) U.S. Cl. 711/136; 711/E12.071

(57) ABSTRACT

An information handling system includes a processor and a storage resource communicatively coupled to the processor. The processor is configured to determine if available overprovisioned storage of the storage resource is less than a threshold overprovisioned storage capacity, establish a new stated capacity for the storage resource in response to a determination that the available overprovisioned storage of the storage resource is less than the threshold overprovisioned storage capacity, and communicate to the processor an indication of the new stated capacity.

### TECHNICAL FIELD

The present disclosure relates in general to input/output (I/O) communication, and more particularly to write-life extension of storage resources.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use an array of storage resources, such as a Redundant Array of Independent Disks (RAID), for example, for storing information. Arrays of storage resources typically utilize multiple disks to perform input and output operations and can be structured to provide redundancy which may increase fault tolerance. Other advantages of arrays of storage resources may be increased data integrity, throughput and/or capacity. In operation, one or more storage resources disposed in an array of storage resources may appear to an operating system as a single logical storage unit or “logical unit.” Implementations of storage resource arrays can range from a few storage resources disposed in a server chassis, to hundreds of storage resources disposed in one or more separate storage enclosures.

The concept of caching data in a cache has long been employed in information handling systems. Generally speaking, a cache is a block of memory for temporarily storing data that may be likely to be accessed again. Maintaining a cache of data likely to be accessed again may increase system performance. For example, an information handling system may be coupled to a storage array via a network, but may maintain a storage cache local to the information handling system. Data read from or written to the remote storage array that is likely to be accessed again (e.g., data that is most-recently used and/or most-frequently used) may be stored to the local cache, so that the information handling system can access the cached data from the cache, rather than accessing the data from the remote storage array which may take a longer period of time, due to latency inherent in performing input/output operations over a network.

More recently, the industry has increasingly implemented caches using solid-state storage devices. However, one well-known disadvantage of solid-state storage devices are their limited write lives. Solid-state storage devices often employ flash memory. Typically, a cell of a flash-based solid-state storage device can be only be erased (and therefore written) a limited number of times before it fails. Accordingly, over time a sufficient number of cells may fail, thus rendering the solid-state storage device incapable or receiving further write data.

### SUMMARY

In accordance with the teachings of the present disclosure, the disadvantages and problems associated with the write life of storage resources have been substantially reduced or eliminated.

In one embodiment, an information handling system includes a processor and a storage resource communicatively coupled to the processor. The processor is configured to determine if available overprovisioned storage of the storage resource is less than a threshold overprovisioned storage capacity, establish a new stated capacity for the storage resource in response to a determination that the available overprovisioned storage of the storage resource is less than the threshold overprovisioned storage capacity, and communicate to the processor an indication of the new stated capacity.

In another embodiment, a storage resource includes a plurality of dies and a controller communicatively coupled to the plurality of dies. Each die includes a plurality of memory cells for electronically storing data. The controller is configured to determine if available overprovisioned storage of the storage resource is less than a threshold overprovisioned storage capacity, establish a new stated capacity for the storage resource in response to a determination that the available overprovisioned storage of the storage resource is less than the threshold overprovisioned storage capacity, and communicate to the processor an indication of the new stated capacity.

In yet another embodiment, a method includes determining if available overprovisioned storage of a storage resource is less than a threshold overprovisioned storage capacity, establishing a new stated capacity for the storage resource in response to a determination that the available overprovisioned storage of the storage resource is less than the threshold overprovisioned storage capacity, and communicating to a processor communicatively coupled to the storage resource an indication of the new stated capacity.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system including a storage array, in accordance with embodiments of the present disclosure;

FIG. 2 illustrates a block diagram of an example cache, in accordance with embodiments of the present disclosure; and

FIG. 3 illustrates a flow chart of an example method for extending the write life of storage resource, in accordance with embodiments of the present disclosure.

### DETAILED DESCRIPTION

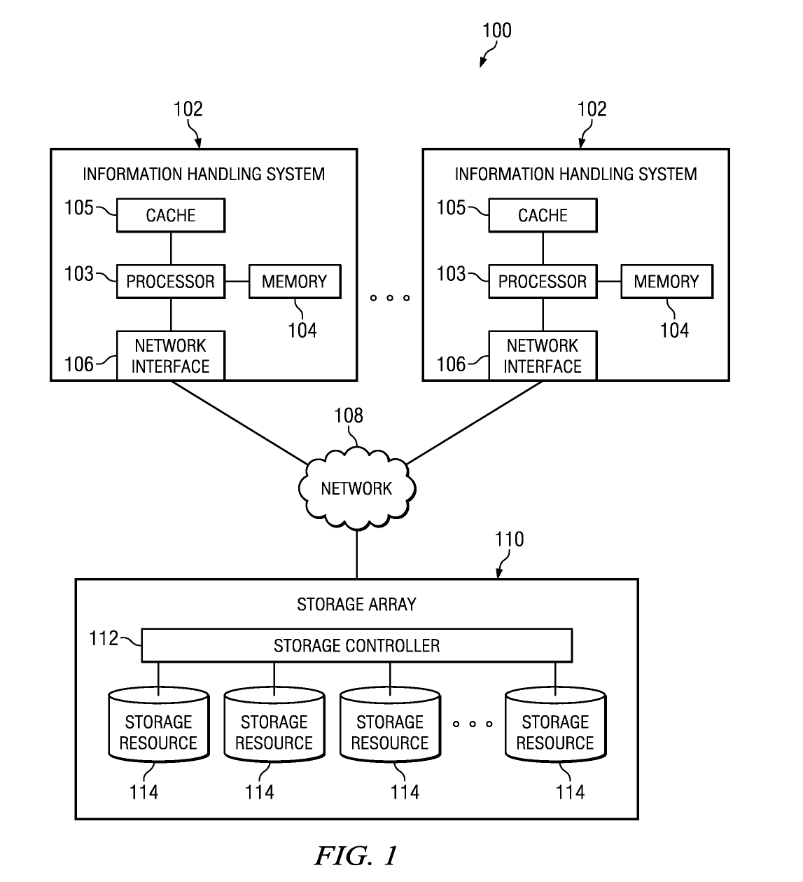

Preferred embodiments and their advantages are best understood by reference to FIGS. 1-3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

As discussed above, an information handling system may include or may be coupled to an array of storage resources. The array of storage resources may include a plurality of storage resources, and may be operable to perform one or more input and/or output storage operations, and/or may be structured to provide redundancy. In operation, one or more storage resources disposed in an array of storage resources may appear to an operating system as a single logical storage unit or “logical unit.”

In certain embodiments, an array of storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity checking. As known in the art, RAIDs may be implemented according to numerous RAID standards, including without limitation, RAID 0, RAID 1, RAID 0+1, RAID 3, RAID 4, RAID 5, RAID 6, RAID 01, RAID 03, RAID 10, RAID 30, RAID 50, RAID 51, RAID 53, RAID 60, RAID 100, etc.

FIG. 1 illustrates a block diagram of an example system 100 including a storage array 110, in accordance with embodiments of the present disclosure. As depicted in FIG. 1, system 100 may include one or more information handling systems 102, a network 108, and a storage array 110. An information handling system 102 may comprise a processor 103, a memory 104 communicatively coupled to processor 103, a cache 105, and a network interface 106 communicatively coupled to processor 103. In certain embodiments, an information handling system 102 may comprise a server. In other embodiments, information handling system 102 may comprise a personal computer (e.g., a desktop computer, laptop computer, mobile computer, notebook computer, and/or handheld computer). An information handling system 102 may generally be operable to receive data from and/or communicate data to storage array 110. A processor 103 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, a processor 103 may interpret and/or execute program instructions and/or process data stored in an associated memory 104, cache 105, and/or another component of its associated information handling system 102. In the same or alternative embodiments, processor 102 may communicate data to and/or from storage array 110 (e.g., via network 108). A memory 104 may be communicatively coupled to an associated processor 103 and may comprise any system, device, or apparatus operable to retain program instructions or data for a period of time. Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to an associated information handling system 102 is turned off.

A cache 105 may be communicatively coupled to an associated processor 103 and may comprise any system, device, or apparatus operable to temporarily store program instructions or data read from or written to storage array 110 that may be likely to be accessed again by processor 103 (e.g., most-recently used and/or most-frequently used data). Cache 105 may comprise random access memory (RAM), electrically erasable programmable read-only memory (EEPROM), a PCMCIA card, flash memory, magnetic storage, opto-magnetic storage, or any suitable selection and/or array of volatile or non-volatile memory. In particular embodiments, a cache 105 may comprise a solid-state storage device. Although in FIG. 1 cache 105 is illustrated above processor 103, cache 105 is not necessarily configured to issue commands to processor 103.

In one embodiment, information handling systems 102 may comprise a cluster of servers. Cache 105 of each such information handling system may be incorporated into a higher-level cache that is accessible to any entity accessing the cluster of servers. Such a higher-level cache may pool the resources of each such cache 105 and be coordinated across the operation of information handling systems 102. In such an embodiment, such a higher-level cache may participate in cache operations on each such cache 105, such as determining whether to evict or erase data from a given cache 105 in order to make room for new data.

A network interface 106 may include any suitable system, apparatus, or device operable to serve as an interface between an information handling system 102 and an external network (e.g., network 108 or other network). A network interface 106 may enable an information handling system 102 to communicate with network 108 using any suitable transmission protocol and/or standard, including without limitation all transmission protocols and/or standards enumerated below with respect to the discussion of network 108. In certain embodiments, a network interface 106 may include a network interface card (NIC). In the same or alternative embodiments, a network interface 106 may be configured to communicate via wireless transmissions. In the same or alternative embodiments, a network interface 106 may provide physical access to a networking medium and/or provide a low-level addressing system (e.g., through the use of Media Access Control addresses).

Network 108 may be a network and/or fabric configured to communicatively couple information handling systems to each other, other information handling systems, storage array 110, and/or other devices. In certain embodiments, network 108 may include a communication infrastructure, which provides physical connections, and a management layer, which organizes the physical connections of information handling systems 102 and other devices coupled to network 108. Network 108 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 108 may transmit data using any storage and/or communication protocol, including without limitation, Fibre Channel, Frame Relay, Ethernet Asynchronous Transfer Mode (ATM), Internet protocol (IP), or other packet-based protocol, and/or any combination thereof. Network 108 and its various components may be implemented using hardware, software, or any combination thereof.

Storage array 110 may comprise any system, device, or apparatus having a plurality of physical storage resources 114 communicatively coupled to network 108 and/or information handling systems 102 via storage controller 112. Storage resources 114 may include hard disk drives, magnetic tape libraries, optical disk drives, magneto-optical disk drives, compact disk drives, compact disk arrays, disk array controllers, and/or any computer-readable medium operable to store data. In some embodiments, storage resources 114 may form all or part of a redundant storage array (e.g., a RAID). In such embodiments, storage resources 114 participating in the redundant storage array may appear to an operating system executing on an information handling system 102 as a single logical storage unit or virtual resource. Thus, information handling system 102 may “see” a logical unit instead of seeing each individual physical storage resource 114. Storage resources 114 may be housed in one or more storage enclosures configured to hold and power storage resources 114.

As depicted in FIG. 1, storage resources 114 may each be communicatively coupled to a storage controller 112.

Storage controller 112 may comprise any suitable system, device, or apparatus that manages physical storage resources 114 of storage array 110 and/or presents them to information handling system 102 as logical units and/or virtual storage resources, as is described in greater detail below. In some embodiments, storage controller 112 may comprise a RAID controller. For example, if a RAID is implemented using the physical storage resources 114 of storage array 110, controller 112 may control how stored data is mirrored and/or striped among physical storage resources 114, and may present such RAID as a single logical unit or virtual storage resource to information handling system 102. In some example embodiments, storage controller 112 may be an integral part of a storage enclosure housing one or more of physical storage resources 114. In other embodiments, storage controller 112 may be an integral part of information handling system 102.

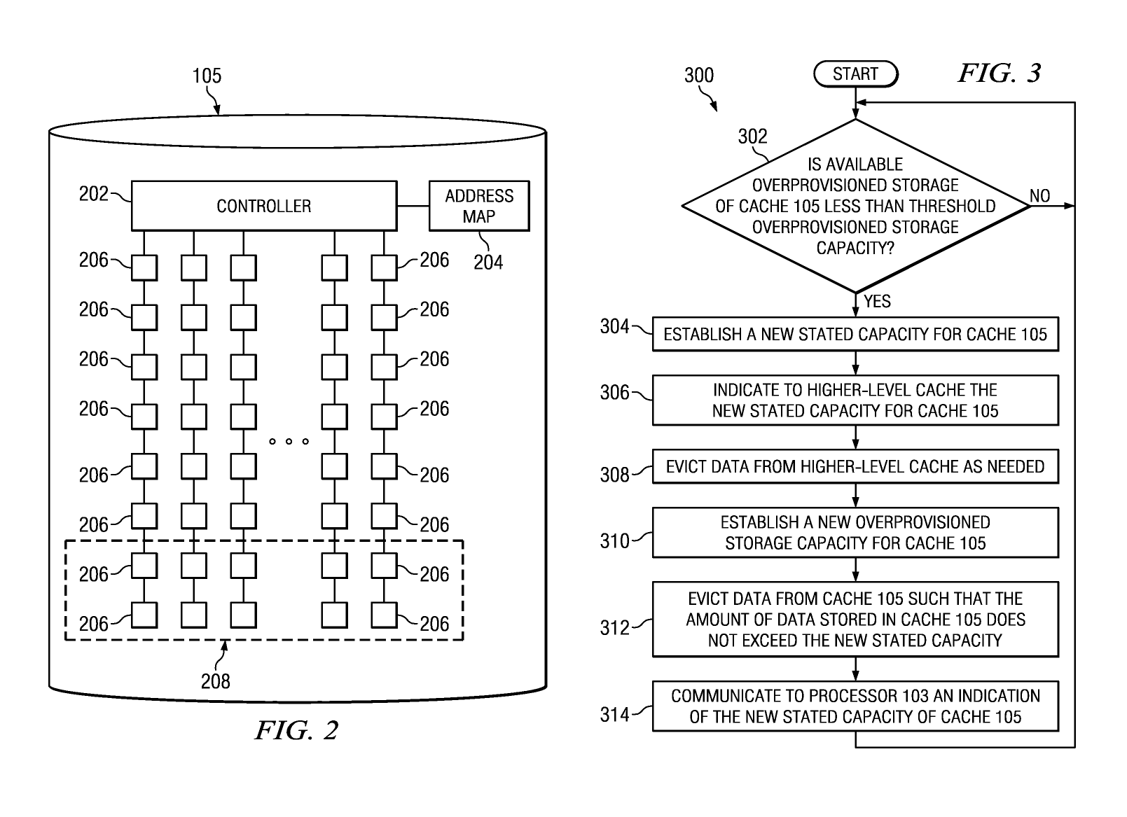

FIG. 2 illustrates a block diagram of an example cache 105, in accordance with embodiments of the present disclosure. As depicted in FIG. 2, a cache 105 may comprise a solid-state storage device with a controller 202, an address map 204, and a plurality of dies 206.

Controller 202 may comprise any system, device, or apparatus configured to bridge and/or couple individual storage components (e.g., dies 206) to information handling systems 102. In some embodiments, controller 202 may comprise a processor embedded in cache 105. In other embodiments, controller 202 may comprise a processor embedded in another cache, such as a cache resident across a plurality of servers in a cluster. In yet other embodiments, controller 202 may comprise a controller of a RAID controller or system encompassing a cache resident across a plurality of servers. Any suitable processor with access to solid state device memory may be used to implement such a cache. In these and other embodiments, controller 202 may execute firmware-level code to perform its various functions. Functions that may be performed by controller 202 include error correction, wear leveling, bad block mapping, read scrubbing and read disturb management, read and write caching, garbage collection, and/or encryption. In addition or alternatively, controller 202 may perform functionality related to write-life extension of its associated cache, as described in greater detail below.

Address map 204 may include any map, table, list, or other suitable data structure accessible to controller 202 and configured to store relationships between virtual addresses (e.g., virtual logical block addresses) and physical addresses (e.g., physical logical block addresses). A virtual address may be used by an information handling system 102 and/or storage controller 112 to address particular data in storage array 110. On the other hand, a physical address may be used by a cache 105 to address an actual physical location of data in cache 105. Accordingly, controller 202 may use address map 204 to translate a virtual address received in an input/output (I/O) request to a physical address. In some embodiments, address map 204 may also maintain status information for data stored in the cache 105, such as its frequency of access and/or how recent it was accessed, for example. Controller 202 may use such status information to determine when to evict or erase data from cache 105 in order to make room for new data.

A die 206 may be communicatively coupled to controller 202 and may comprise an integrated circuit configured to electronically store data. In some embodiments, a die 206 may comprise a plurality of memory cells (e.g., NAND-based flash memory cells or NOR-based flash memory cells). A cache 105 may comprise any suitable arrangement or architecture of dies 206 (including, as depicted in FIG. 2, an arrangement of columns).

In some embodiments, a portion of the dies 206 present in cache 105 may be designated by controller 202 as overprovisioned storage 208. Overprovisioned storage 208 may be defined as storage capacity of a storage resource that is not reported by a cache 105 (e.g., to processor 103) as residing within the nominal storage capacity of the cache 105. For example, a cache 105 may have a stated capacity of one gigabyte (GB), but may actually have 1.1 GB in storage capacity—the additional 0.1 GB of excess capacity may be overprovisioned storage. Such overprovisioned storage 208 may be present to allow for increased endurance, enhanced wear leveling, improved garbage collection, and/or improved performance. As a specific example, in the event of a failure of a die 206 or other failure within a storage resource 206, controller 202 may de-allocate such failed die 206 and allocate a die 206 residing in the overprovisioned storage 208 to essentially replace the failed die 206. Although overprovisioned storage 208 is depicted in FIG. 2 as comprising a contiguous set of dies 206, it is understood that overprovisioned storage 208 may comprise any suitable collection of dies 206, whether contiguous or disjoint.

As briefly described in the “Background” section above, a disadvantage of traditional solid-state storage devices are their limited write lives. As a solid-state storage device ages, more and more dies fail, and eventually, the capacity of the overprovisioned storage becomes zero (i.e., the non-failed capacity of the solid-state storage device equals the stated capacity). At such point, a traditional solid-state storage device may then cease writing input/output (I/O) data to the device, and the solid-state storage device becomes a read-only storage device. To eliminate or reduce such disadvantages, in accordance with the present disclosure, controller 202 may be configured to reduce the state capacity of cache 105 (as described in greater detail below), thus freeing capacity to be used as overprovisioned storage, and delaying the point at which cache 105 can no longer provide write access due to a lack of overprovisioned storage.

FIG. 3 illustrates a flow chart of an example method 300 for extending the write life of storage resource, in accordance with embodiments of the present disclosure. According to at least one embodiment, method 300 preferably begins at step 302. As noted above, teachings of the present disclosure may be implemented in a variety of configurations of information handling system 100. As such, the preferred initialization point for method 300 and the order of the steps 302-314 comprising method 300 may depend on the implementation chosen.

At step 302, controller 202 may monitor the available overprovisioned storage of cache 105 and determine if it is less than a threshold overprovisioned storage capacity. In some embodiments, the threshold overprovisioned storage capacity may be an absolute value of storage capacity (e.g., megabytes). In other embodiments, the threshold overprovisioned storage capacity may be a certain fraction or percentage of the then-current stated capacity of cache 105 (e.g., one-tenth or ten percent). If the available overprovisioned storage of cache 105 is less than the threshold overprovisioned storage capacity, method 300 may proceed to step 304. Otherwise, step 302 may repeat until the available overprovisioned storage of cache 105 is less than the threshold overprovisioned storage capacity.

At step 304, in response to a determination that the available overprovisioned storage of cache 105 is less than the threshold overprovisioned storage capacity, controller 202 may establish a new stated capacity for cache 105. In some embodiments, the new stated capacity may be a particular absolute value of storage capacity (e.g., 512 megabytes). In other embodiments, the new stated capacity may be a certain fraction or percentage of the then-current stated capacity of cache 105 (e.g., three-fourths or 75%).

At step 306, if a higher-level cache incorporating cache 105 exists, the controllers for the higher-level cache may be notified of the new stated capacity determined in step 304. In step 308, such controllers for the high-level cache may evict data as needed in view of the new stated capacity. After such eviction is made, controller 202 may be notified.

At step 310, after establishing the new stated capacity, controller 202 may establish a new overprovisioned storage capacity for cache 105. In some embodiments, the new stated capacity may be a particular absolute value of storage capacity (e.g., 512 megabytes). In other embodiments, the new overprovisioned storage capacity may be a certain fraction or percentage of the new stated capacity of cache 105 (e.g., one-fourth or 25%). In these and other embodiments, the new overprovisioned storage capacity for cache 105 may be equal to the overall non-failed capacity of cache 105 minus the new stated capacity for cache 105.

At step 312, controller 202 may evict data from cache 105 such that the amount of data stored in cache 105 does not exceed the new stated capacity. Controller 202 may evict data based on any suitable policy or algorithm. For example, in some embodiments, controller 202 may evict the least-recently used data present in cache 105. In these and other embodiments, controller may evict the least-frequency used data present in cache 105. In addition, garbage collection may be performed on cache 105 or other caches in which any capacity of cache 105 or other caches that contain invalid data are reclaimed. In one embodiment, such reclamation may be made for overprovisioned portions of cache 105.

At step 314, controller 202 may communicate to processor 103 an indication of the new stated capacity of cache 105, and processor 103 may interact with cache 105 accordingly. In one embodiment, such an indication may be implemented using a Self-Monitoring, Analysis and Reporting Technology (“SMART”) interaction as, for example, an interrupt or polling procedure. If higher-level caches incorporating cache 105 exist, the controllers for such higher-level caches may be notified of the new state capacity. After completion of step 314, method 300 may proceed again to step 302.

Although FIG. 3 discloses a particular number of steps to be taken with respect to method 300, it is understood that method 300 may be executed with greater or lesser steps than those depicted in FIG. 3. In addition, although FIG. 3 discloses a certain order of steps to be taken with respect to method 300, the steps comprising method 300 may be completed in any suitable order.

Method 300 may be implemented using information handling system 100 or any other system operable to implement method 300. In certain embodiments, method 300 may be implemented partially or fully in software embodied in tangible computer readable media.

In addition, although most of the foregoing discussion of write-life extension has been directed to caches, the methods and systems disclosed herein may be generally applied to extend the write life of any suitable storage resource, whether or not embodied as a solid-state storage device and whether or not embodied a cache.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a processor; and
a storage resource communicatively coupled to the processor and configured to:
determine if available overprovisioned storage of the storage resource is less than a threshold overprovisioned storage capacity;
establish a new stated capacity for the storage resource in response to a determination that the available overprovisioned storage of the storage resource is less than the threshold overprovisioned storage capacity; and
communicate to the processor an indication of the new stated capacity.

2. An information handling system according to claim 1, the storage resource comprising a solid-state storage device.

3. An information handling system according to claim 1, the storage resource comprising a cache.

4. An information handling system according to claim 1, the new stated capacity equal to a particular percentage of a present stated capacity for the storage resource.

5. An information handling system according to claim 1, the threshold overprovisioned storage capacity equal to a particular percentage of a present stated capacity for the storage resource.

6. An information handling system according to claim 1, the storage resource further configured to establish a new overprovisioned storage capacity for the storage resource.

7. An information handling system according to claim 1, the storage resource further configured to evict data from the storage resource such that data stored in the storage resource does not exceed the new stated capacity.

8. An information handling system according to claim 7, the storage resource configured to evict the data in accordance with at least one of a least-recently used policy and a least-frequently used policy.

9. A storage resource comprising:
a plurality of dies, each die comprising a plurality of memory cells for electronically storing data; and
a controller communicatively coupled to the plurality of dies and configured to:
determine if available overprovisioned storage of the storage resource is less than a threshold overprovisioned storage capacity;
establish a new stated capacity for the storage resource in response to a determination that the available overprovisioned storage of the storage resource is less than the threshold overprovisioned storage capacity; and
communicate to the processor an indication of the new stated capacity.

10. A storage resource according to claim 9, the plurality of dies comprising a solid-state storage media.

11. A storage resource according to claim 9, the storage resource comprising a cache.

12. A storage resource according to claim 9, the new stated capacity equal to a particular percentage of a present stated capacity for the storage resource.

13. A storage resource according to claim 9, the threshold overprovisioned storage capacity equal to a particular percentage of a present stated capacity for the storage resource.

14. A storage resource according to claim 9, the controller further configured to establish a new overprovisioned storage capacity for the storage resource.

15. A storage resource according to claim 9, the controller further configured to evict data from the storage resource such that data stored in the storage resource does not exceed the new stated capacity.

16. A storage resource according to claim 15, the controller configured to evict the data in accordance with at least one of a least-recently used policy and a least-frequently used policy.

17. A method comprising:
determining if available overprovisioned storage of a storage resource is less than a threshold overprovisioned storage capacity;
establishing a new stated capacity for the storage resource in response to a determination that the available overprovisioned storage of the storage resource is less than the threshold overprovisioned storage capacity; and
communicating to a processor communicatively coupled to the storage resource an indication of the new stated capacity.

18. A method according to claim 17, the new stated capacity equal to a particular percentage of a present stated capacity for the storage resource.

19. A method according to claim 17, the threshold overprovisioned storage capacity equal to a particular percentage of a present stated capacity for the storage resource.

20. A method according to claim 17, comprising establishing a new overprovisioned storage capacity for the storage resource.

21. A method according to claim 17, further comprising evicting data from the storage resource such that data stored in the storage resource does not exceed the new stated capacity.
